(19) United States
(12) Patent Application Publication
(10) Pub. No.: US 2018/0074582 A1
(43) Pub. Date: Mar. 15, 2018

(54) SYSTEMS, DEVICES, AND METHODS FOR WEARABLE HEADS-UP DISPLAYS AS WIRELESS CONTROLLERS

(71) Applicant: THALMIC LABS INC., Kitchener (CA)

(72) Inventors: Thomas Mahon, Guelph (CA); Brent Bisaillion, Kitchener (CA)

(21) Appl. No.: 15/806,045

(22) Filed: Nov. 7, 2017

Related U.S. Application Data
(63) Continuation of application No. 15/363,970, filed on Nov. 29, 2016.
(60) Provisional application No. 62/261,653, filed on Dec. 1, 2015.

(51) Int. Cl. G06F 3/01; G06F 3/0484; G06F 3/038; H04N 21/422; H04N 5/44; G02B 27/01; G06F 3/0482; G06F 3/0481

(52) U.S. Cl. CPC G06F 3/013; G06F 3/04842; G06F 3/0383; H04N 21/42222; H04N 5/4403; H04N 2005/4428; G02B 27/017; G06F 3/0484; G06F 3/0482; G06F 3/04817; G06F 2203/0384; G06F 3/04847

(57) ABSTRACT

Systems, devices, and methods that operate a wearable heads-up display (“WHUD”) as a remote controller to wirelessly control at least one other electronic device are described. The WHUD displays a visual control interface including a set of user-selectable icons that each correspond to a respective function for the electronic device under wireless/remote control. The WHUD includes an eye tracker that detects when the user is looking/gazing at a particular one of the icons in the visual control interface. The user provides an indication that he/she wishes to select the particular icon at which he/she is gazing/looking (e.g., by dwelling his/her gaze on the particular icon or by performing a selection action via a separate portable interface device). In response, the WHUD wirelessly transmits a signal that provides data and/or instructions for the electronic device under wireless/remote control to effect the particular function selected by the user.

### TECHNICAL FIELD

The present systems, devices, and methods generally relate to human-computer interaction and particularly relate to using a wearable heads-up display as a wireless controller for interacting with another electronic device.

### BACKGROUND

### Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be “wireless” (i.e., designed to operate without any wire-connections to other, non-portable electronic systems); however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

Because they are worn on the body of the user, visible to others, and generally present for long periods of time, form factor (e.g., size, geometry, and appearance) is a major design consideration in wearable electronic devices.

### Head-Mounted Displays

A head-mounted display is a form of wearable electronic device that is worn on the user's head and, when so worn, positions a display in the user's field of view. This enables the user to see content displayed on the display at all times, without using their hands to hold the display and regardless of the direction in which the user's head is facing. A wearable head-mounted display may completely occlude the external environment from the user's view, in which case the display is well-suited for virtual reality applications. An example of a virtual reality head-mounted display is the Oculus Rift®.

In an alternative implementation, a head-mounted display may be at least partially transparent and/or sized and positioned to only occupy a portion of the user's field of view. A wearable heads-up display is a head-mounted display that enables the user to see displayed content but does not prevent the user from being able to see their external environment. Wearable heads-up displays are well-suited for augmented reality applications. Examples of wearable heads-up displays include: the Google Glass®, the Optinvent Ora®, the Epson Moverio®, the Microsoft HoloLens®, and the Sony Glasstron®, just to name a few.

### Human-Electronics Interfaces and Devices

A human-electronics interface mediates communication between a human and one or more electronic device(s). In general, a human-electronics interface is enabled by one or more electronic interface device(s) that: a) detect inputs effected by the human and convert those inputs into electric signals that can be processed or acted upon by the one or more electronic device(s), and/or b) provide outputs to the human from the one or more electronic device(s), where the user is able to understand some information represented by the outputs. A human-electronics interface may be one-directional or bidirectional, and a complete interface may make use of multiple interface devices. For example, the computer mouse is a one-way interface device that detects inputs effected by a user of a computer and converts those inputs into electric signals that can be processed by the computer, while the computer's display or monitor is a one-way interface device that provides outputs to the user in a visual form through which the user can understand information. Together, the computer mouse and display complete a bidirectional human-computer interface (“HCI”). A HCI is an example of a human-electronics interface.

A wearable electronic device may function as an interface device if, for example, the wearable electronic device includes sensors that detect inputs effected by a user and transmits signals to another electronic device based on those inputs. Sensor-types and input-types may each take on a variety of forms, including but not limited to: tactile sensors (e.g., buttons, switches, touchpads, or keys) providing manual control, acoustic sensors providing voice-control, electromyography sensors providing gestural control, and/or accelerometers providing gestural control.

The remote controller is a very common and well-established form of human-electronics interface device. The basic design for a remote controller is a battery-powered, wireless, handheld electronic device with physical buttons actuatable by the user and a means for wirelessly transmitting signals to another electronic device in response to actuation of said buttons by the user. Though very common, typical remote controllers are cumbersome, indiscreet, and awkward to use because they completely tie up at least one of the user's hands while in use. There is a need in the art for a less intrusive way for a user to remotely interact with electronic devices.

### BRIEF SUMMARY

A method of operating a wearable system to wirelessly control an electronic device may be summarized as including: displaying, by a wearable heads-up display, a visual control interface for the electronic device, the visual control interface including a set of user-selectable icons that each correspond to a respective function for the electronic device; detecting, by an eye tracker of the wearable heads-up display, that a user of the wearable heads-up display is gazing at a particular user-selectable icon in the visual control interface; receiving, by the wearable heads-up display, an indication from the user to select the particular user-selectable icon in the visual control interface; and wirelessly transmitting, by a wireless transmitter of the wearable heads-up display, a wireless signal to effect a function of the electronic device corresponding to the particular user-selectable icon selected by the user.

Receiving, by the wearable heads-up display, an indication from the user to select the particular user-selectable icon in the visual control interface may include detecting, by the eye tracker of the wearable heads-up display, that the user is continuously gazing at the particular user-selectable icon for a defined amount of time. The defined amount of time may be selected from a group consisting of: about one second, about two seconds, about three seconds, about four seconds, and about five seconds.

Receiving, by the wearable heads-up display, an indication from the user to select the particular user-selectable icon in the visual control interface may include receiving, by a wireless receiver of the wearable heads-up display, a wireless signal transmitted from a portable interface device, the wireless signal representative of a deliberate selection action performed by the user while the eye tracker of the wearable heads-up display is detecting that the user is gazing at the particular user-selectable icon in the visual control interface. The portable interface device may be selected from a group consisting of: a smartphone, a gesture control armband, a wearable device, and a batteryless and wireless portable interface device.

The method may further include: receiving, by the electronic device, the wireless signal wirelessly transmitted by the wearable heads-up display; and effecting, by the electronic device, a function of the electronic device corresponding to the particular user-selectable icon selected by the user.

The electronic device may be selected from a group consisting of: a remote-controlled device, a television, a personal computer, a laptop computer, a music player, a telephone, and a video game console. The wearable heads-up display may include a processor and a non-transitory processor-readable storage medium communicatively coupled to the processor, wherein the non-transitory processor-readable storage medium stores data and/or processor-executable instructions, and wherein: displaying, by a wearable heads-up display, a visual control interface for the electronic device includes executing, by the processor, the data and/or processor-executable instructions to cause the wearable heads-up display to display the visual control interface for the electronic device; detecting, by an eye tracker of the wearable heads-up display, that a user of the wearable heads-up display is gazing at a particular user-selectable icon in the visual control interface includes executing, by the processor, the data and/or processor-executable instructions to cause the eye tracker of the wearable heads-ups display to detect that the user is gazing at the particular user-selectable icon in the visual control interface; and wirelessly transmitting, by a wireless transmitter of the wearable heads-up display, a wireless signal to effect a function of the electronic device corresponding to the particular user-selectable icon selected by the user includes executing, by the processor, the data and/or processor-executable instructions to cause the wireless transmitter of the wearable heads-up display to wirelessly transmit the wireless signal to effect the function of the electronic device corresponding to the particular user-selectable icon selected by the user.

The set of user-selectable icons in the visual control interface displayed by the wearable heads-up display may include at least one user-selectable icon selected from a group consisting of: a textual icon corresponding to a particular function for the electronic device, a pictorial icon corresponding to a particular function for the electronic device, and a combined textual and pictorial icon corresponding to a particular function for the electronic device.

Receiving, by the wearable heads-up display, an indication from the user to select the particular user-selectable icon in the visual control interface may include detecting, by the eye tracker of the wearable heads-up display, that the user is gazing at a selection button in the visual control interface after detecting, by the eye tracker of the wearable heads-up display, that the user is gazing at a particular user-selectable icon in the visual control interface.

A wearable system operative to wirelessly control an electronic device may be summarized as including: a wearable heads-up display that includes: a processor; an eye tracker communicatively coupled to the processor; a wireless transmitter communicatively coupled to the processor; and a non-transitory processor-readable storage medium communicatively coupled to the processor, wherein the non-transitory processor-readable storage medium stores data and/or processor-executable instructions that, when executed by the processor, cause: the wearable heads-up display to display a visual control interface for the electronic device, the visual control interface including a set of user-selectable icons that each correspond to a respective function for the electronic device; the eye tracker to detect that a user of the wearable heads-up display is gazing at a particular user-selectable icon in the visual control interface; and in response to receiving, by the wearable heads-up display, an indication from the user to select the particular user-selectable icon in the visual control interface, the wireless transmitter of the wearable heads-up display to wirelessly transmit a wireless signal to effect a function of the electronic device corresponding to the particular user-selectable icon selected by the user. The electronic device may be selected from a group consisting of: a remote-controlled device, a television, a personal computer, a laptop computer, a music player, a telephone, and a video game console. The set of user-selectable icons in the visual control interface displayed by the wearable heads-up display may include at least one user-selectable icon selected from a group consisting of: a textual icon corresponding to a particular function for the electronic device, a pictorial icon corresponding to a particular function for the electronic device, and a combined textual and pictorial icon corresponding to a particular function for the electronic device.

The data and/or processor-executable instructions, when executed by the processor, may further cause the eye tracker to detect that the user is continuously gazing at the particular user-selectable icon for a defined amount of time and, in response to detecting that the user is continuously gazing at the particular user-selectable icon for the defined amount of time, provide the indication to select the particular user-selectable icon in the visual control interface. The defined amount of time may be selected from a group consisting of: about one second, about two seconds, about three seconds, about four seconds, and about five seconds.

The wearable system may further include a portable interface device that in use is carried or worn by the user, wherein the portable interface device includes at least one actuator that, when activated by the user, causes the portable interface device to wirelessly transmit a selection signal, and wherein: the data and/or processor-executable instructions stored in the non-transitory processor-readable storage medium of the wearable heads-up display that, when executed by the processor of the wearable heads-up display, cause, in response to receiving, by the wearable heads-up display, an indication from the user to select the particular user-selectable icon in the visual control interface, the wireless transmitter of the wearable heads-up display to wirelessly transmit a wireless signal to effect a function of the electronic device corresponding to the particular user-selectable icon selected by the user cause: in response to wirelessly receiving, by the wearable heads-up display, the selection signal from the portable interface device, the wireless transmitter of the wearable heads-up display to wirelessly transmit a wireless signal to effect a function of the electronic device corresponding to the particular user-selectable icon selected by the user. The portable interface device may be selected from a group consisting of: a smartphone, a gesture control armband, a wearable device, and a batteryless and wireless portable interface device.

The wearable system may further include a portable interface device that in use is carried or worn by the user, wherein the portable interface device includes at least one actuator that, when activated by the user, causes the portable interface device to wirelessly transmit a selection signal, and the indication from the user to select the particular user-selectable icon in the visual control interface may include a receipt, by the wireless receiver of the wearable heads-up display, of the selection signal wirelessly transmitted by the portable interface device when the at least one actuator of the portable interface device is activated by the user.

The data and/or processor-executable instructions, when executed by the processor, may cause the eye tracker to detect that the user is gazing at a selection button in the visual control interface after detecting that the user is gazing at a particular user-selectable icon in the visual control interface. In response to detecting that the user is gazing at the selection button in the visual control interface after detecting that the user is gazing at the particular user-selectable icon in the visual control interface, the data and/or processor-executable instructions, when executed by the processor, may provide the indication to select the particular user-selectable icon in the visual control interface.

The present systems, devices, and methods may be applied to HCIs, but may also be applied to any other form of human-electronics interface, including head-mounted display interfaces.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is an illustrative diagram showing an exemplary application of a wearable heads-up display operated as a remote controller to wirelessly control a television in accordance with an embodiment of the present systems, devices, and methods.

FIG. 2 is an illustrative diagram showing an exemplary application of a wearable heads-up display operated as a remote controller to wirelessly control a remote-controlled helicopter in accordance with an embodiment of the present systems, devices, and methods.

FIG. 3 is an illustrative diagram showing a human-electronics interface in the form of a wearable system that enables a user to easily and discreetly wirelessly control a separate electronic device in accordance with the present systems, devices, and methods.

FIG. 4 is a flow-diagram showing an exemplary method of operating a wearable system as a remote-controller to wirelessly control an electronic device in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with head-mounted displays and electronic devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments describe herein provide systems, devices, and methods that use a wearable heads-up display (“WHUD”) as a wireless controller for interacting with one or more other electronic device(s). In accordance with the present systems, devices, and methods, a WHUD is adapted to provide the functionality of a remote controller and is advantageous over conventional remote controllers because it is more discreet and does not completely tie up either of the user's hands while in use. Furthermore, if a user is already wearing a WHUD for another application, such as for reading and/or for receiving electronic notifications of communications, then it is particularly advantageous for the user to easily and temporarily transition the WHUD into “remote controller” mode and to perform the basic functions of a remote controller (e.g., to control a television, a music player, a radio-controlled (RC) toy, or any other remote-controlled device) without needing to physically operate an additional, dedicated remote controller device.

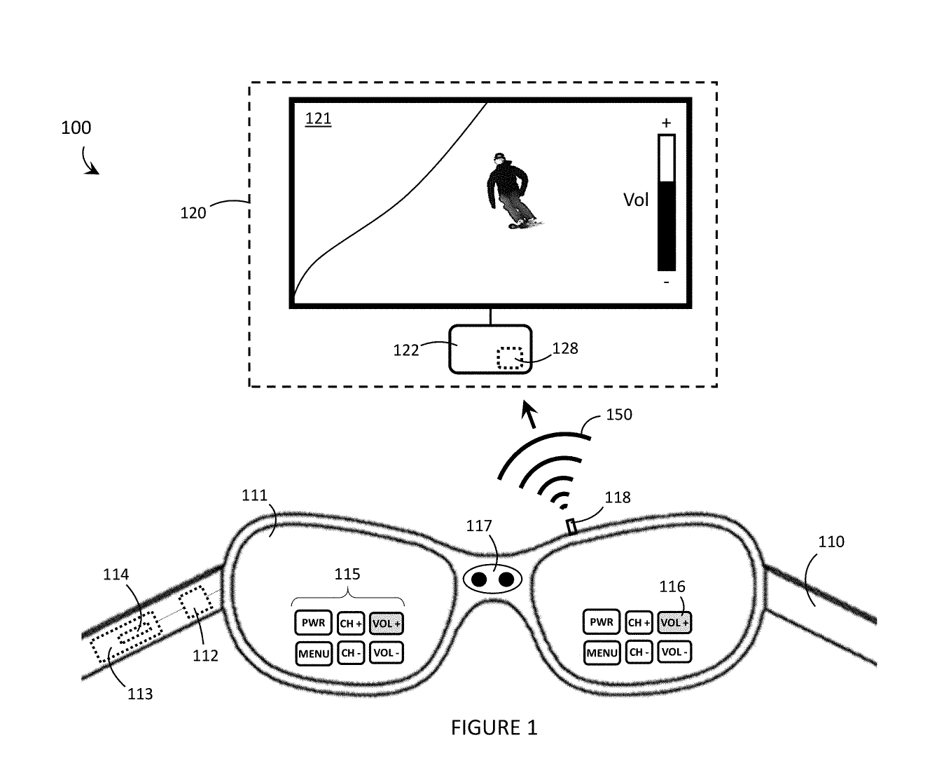

FIG. 1 is an illustrative diagram showing an exemplary application 100 of a WHUD 110 operated as a remote controller to wirelessly control a television 120 in accordance with an embodiment of the present systems, devices, and methods. WHUD 110 includes at least one display 111 (two such displays illustrated in FIG. 1) positioned in the field of view of at least one eye of a user when WHUD 110 is worn on the user's head. One or more display(s) 111 may employ one or more waveguide(s), one or more microdisplay(s), and/or any or all of the display technologies described in US Patent Publication 2015-0205134, U.S. Non-Provisional patent application Ser. No. 14/749,341 (now U.S. Pat. No. 9,477,079), U.S. Non-Provisional patent application Ser. No. 14/749,351 (now U.S. Patent Application Publication No. 2015-0378161), U.S. Non-Provisional patent application Ser. No. 14/749,359 (now US Patent Application Publication No. 2015-0378162), U.S. Provisional Patent Application Ser. No. 62/117,316 (now U.S. Non-Provisional patent application Ser. Nos. 15/046,234 and 15/046,269), U.S. Provisional Patent Application Ser. No. 62/134,347 (now US Patent Application Publication No. 2016-0274365), U.S. Provisional Patent Application Ser. No. 62/156,736 (now U.S. Non-Provisional patent application Nos. 15/145,576, 15/145,609, and 15/145,583), and/or U.S. Provisional Patent Application Ser. No. 62/242,844 (now U.S. Non-Provisional patent application Ser. No. 15/046,254). WHUD 110 also includes a processor 112 (hardware circuitry for instance one or more integrated circuits) communicatively coupled to the at least one display 111 and a non-transitory processor-readable storage medium or memory 113 (e.g., read only memory (ROM), random access memory (RAM), Flash memory, electronically erasable programmable ROM (EEPROM)) communicatively coupled to processor 112. In accordance with the present systems, devices, and methods, memory 113 stores data and/or processor-executable instructions 114 that, when executed by processor 112 of WHUD 110, cause at least one display 111 of WHUD 110 to display a visual control interface 115 for television 120.

Visual control interface 115 includes a set of user-selectable icons 116 (only one called out in FIG. 1) that each correspond to a respective function or operation for television 120. In the illustrated example, the user-selectable icons 116 in visual control interface 115 for television 120 include six icons shaped as graphical buttons: power on/off (“PWR”), a menu function (“MENU,” to cause television 120 to display a menu), channel navigation buttons (“CH+” and “CH−”), and volume control buttons (“VOL+” and “VOL−”), though a person of skill in the art will appreciate that in alternative embodiments any number and/or combination of user-selectable icons 116 controlling any number of functions or operations for television 120 may be included in visual control interface 115. A person of skill in the art will also appreciate that in alternative embodiments one or more user-selectable icon(s) 116 may be visually represented in another form other than as a graphical button corresponding to a particular control function for television 120, such as: a textual icon corresponding to a particular function for television 120, a pictorial (e.g., graphical, symbolic, geometrical) icon corresponding to a particular function for television 120, or a combined textual and pictorial icon corresponding to a particular function for television 120.

WHUD 110 further includes an eye-tracker 117 that is operative to detect the eye position and/or gaze direction of the user and communicatively coupled to processor 112. Eye-tracker 117 includes at least one camera or photodetector to measure light (e.g., visible light or infrared light) reflected from the eye and processor 112 may determine the eye position or gaze direction based on the measured reflections. Eye-tracker 117 may, for example, implement the technology described in U.S. Provisional Patent Application Ser. No. 62/167,767 (now U.S. Non-Provisional patent application Ser. Nos. 15/167,458, 15/167,472, and 15/167,484) and/or U.S. Provisional Patent Application Ser. No. 62/245,792 (now U.S. Non-Provisional patent application Ser. No. 15/331,204), although other eye-tracker technology can be employed. When executed by processor 112, the data and/or processor-executable instructions 114 stored in memory 113 cause eye tracker 117 to detect when the user of WHUD 110 is gazing at a particular user-selectable icon 116 in visual control interface 115. In the illustrated example, the VOL+ control button 116 in visual control interface 115 is highlighted to denote that eye tracker 117 has detected that the user is gazing at the VOL+ control button 116.

When a WHUD (110) is used a remote controller for another electronic device (120) in accordance with the present systems, devices, and methods, a visual control interface (115) for the other electronic device (120) is displayed on the WHUD (110). The visual control interface (115) includes one or multiple user-selectable icon(s) (e.g., one or multiple graphical button(s) corresponding to one or multiple controllable function(s) of the other electronic device (120)) and an eye tracker (117) of the WHUD (110) detects when the user of the WHUD (110) is gazing at a particular user-selectable icon (116) in the visual control interface (115). While the user is gazing at the particular user-selectable icon (116) corresponding to a particular function of operation of the other electronic device (120) that the user wishes to effect, the user may provide an indication to the WHUD (110) to select that particular user-selectable icon (116). This indication may be provided by the user in a variety of different ways depending on the implementation.

As a first example, a user may provide an indication of his or her intention to select a particular user-selectable icon (116) by “dwelling” his or gaze upon the particular user-selectable icon (116). To this end, data and/or processor-executable instructions 114, when executed by processor 112, may further cause eye tracker 117 to detect that the user is continuously gazing at (i.e., “dwelling on”) the particular user-selectable icon 116 for a defined amount of time and, in response to detecting that the user is continuously gazing at, or dwelling on, the particular user-selectable icon 116 for the defined amount of time, provide (to processor 112) an indication to select the particular user-selectable icon 116 in the visual control interface 115. The defined amount of time that the user is required to continuously gaze at the particular user-selectable icon 116 may be specified in data and/or processor-executable instructions 114 and may depend on the specific application and/or the overall user experience desired. As examples, the defined amount of time may be about one second, about two seconds, about three seconds, about four seconds, or about five seconds.

As a second example, a user may provide an indication of his or her intention to select a particular user-selectable icon (116) by: i) gazing at the particular user-selectable icon (116) that he or she wishes to select, which is detected by the eye-tracker (117), and ii) actuating or otherwise triggering a selection operation on a separate portable interface device that is communicatively coupled to the WHUD (110). The separate portable interface device may include, for example: a smartphone, a gesture control armband such as the Myo™ armband from Thalmic Labs Inc., a wearable device like a ring or band, or a batteryless and wireless portable interface device such as that described in U.S. Provisional Patent Application Ser. No. 62/236,060 (now U.S. Non-Provisional patent application Ser. No. 15/282,535). In the case of a separate portable interface device, data and/or processor-executable instructions 114, when executed by processor 112, may further cause WHUD 110 (e.g., processor 112 of WHUD 110) to process a signal wirelessly received from the portable interface device, the signal representative of an indication from the user to select the particular user-selectable icon (116) at which the user is gazing.

As a third example, a user may provide an indication of his or her intention to select a particular user-selectable icon (116) by: i) gazing at the particular user-selectable icon (116) that he or she wishes to select, which is detected by the eye-tracker (117), and ii) next gazing at a dedicated “select” button in the visual control interface (115), which is also detected by the eye-tracker (117). In this case, the memory (113) of the WHUD (110) may include data and/or processor-executable instructions (114) that cause the processor (112) to interpret a registered (i.e., detected by eye-tracker 117) gaze at the “select” button as an indication from the user that he or she wishes to select the last (i.e., most recently previous) button at which the eye tracker (117) had registered a gaze prior to registering the gaze at the “select” button.

WHUD 110 includes a wireless transmitter 118 communicatively coupled to processor 112. Wireless transmitter 118 may or may not also include wireless receiver functionality (i.e., as a wireless transceiver or radio) depending on the needs of the particular implementation. For example, an implementation that relies on dwell time as a selection indication from the user may not require wireless receiver functionality whereas an implementation that relies on a wireless signal from a separate portable interface device as a selection indication from the user may require wireless receiver functionality. Generally, in response to WHUD 110 receiving an indication from the user to select particular user-selectable icon 116 in visual control interface 115, data and/or processor-executable instructions 114 cause wireless transmitter 118 to wirelessly transmit a wireless signal 150 (e.g., in the radio or microwave portion of the electromagnetic spectrum, or in the infrared portion of the electromagnetic spectrum, or an ultrasonic signal) to effect a function or operation of television 120. Wireless signal 150 encodes or embodies data and/or instructions that, when received by television 120 (or an electronic receiver communicatively coupled thereto) cause television 120 to effect the control function or operation corresponding to the particular user-selectable icon 116 selected by the user. Wireless transmitter 118 and wireless signal 150 may implement a proprietary wireless communication protocol or any known wireless communication protocol, including without limitation Bluetooth®, Zigbee®, WiFi®, Near Field Communication (NFC), and/or the like.

FIG. 1 illustrates an exemplary application 100 in which WHUD 110 is used as a remote controller to wirelessly control another electronic device, and that other electronic device is a television system 120. Television system 120 includes a display/monitor 121 communicatively coupled to control electronics 122. Control electronics 122 may be integrated with display/monitor 121 (e.g., as a “Smart TV”) or control electronics 122 may be included in a separate component/box, such as an Apple TV®, a Google Chromecast®, a Roku®, an Amazon Fire TV®, or the like. Regardless of the specific implementation details, control electronics 122 of television system 120 include a wireless receiver 128 (e.g., a radio receiver, an infrared receiver, or an ultrasonic microphone) operative to receive wireless signals 150 from WHUD 110. In the illustrated example, the user is gazing at the VOL+ button 116 in visual control interface 115 displayed on WHUD 110 and the user concurrently provides an indication (e.g., via gaze dwell time, via a selection action performed with a separate portable interface device, or via a selection button within visual control interface 115) to select the VOL+ control function. In response, wireless transmitter 118 of WHUD 110 transmits a wireless signal 150 that encodes or embodies data and/or instructions to cause television system 120 to perform the VOL+ control function. Wireless receiver 128 of television system 120 receives wireless signal 150 and, in response, television system 120 effects an increase in volume as depicted in FIG. 1.

The application 100 of WHUD 110 to wirelessly control television system 120 is used herein as an illustrative example of the operation of a WHUD as a remote controller. In accordance with the present systems, devices, and methods, a WHUD with eye tracking capability and a wireless transmitter may be operated to wirelessly control virtually any other electronic device that is capable of wireless/remote control operation, including without limitation: a personal computer, a laptop computer, a music player, a telephone, a video game console, a smart or networked thermostat, a smart or networked light bulb, a radio, and/or a remote-controlled device.

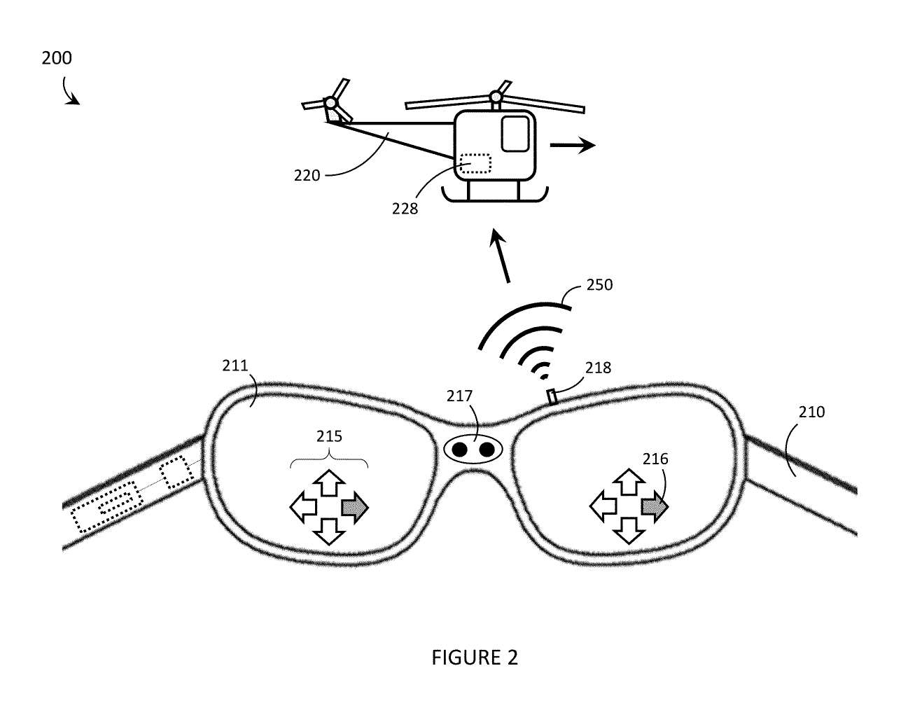

FIG. 2 is an illustrative diagram showing an exemplary application 200 in which a WHUD 210 is operated as a remote controller to wirelessly control a remote-controlled helicopter 220 in accordance with an embodiment of the present systems, devices, and methods. WHUD 210 is substantially similar to WHUD 110 from FIG. 1, except that in application 200 display(s) 211 of WHUD 210 display visual control interface 215 comprising four user-selectable icons in the form of four directional arrows (i.e., pictorial icons) that correspond to respective controls for the movements of helicopter 220. In the illustrated application 200, eye tracker 217 of WHUD 210 detects that the user is gazing at the “right” arrow 216 of visual control interface 215. Concurrently, the user provides an indication to WHUD 210 (e.g., by dwelling his/her gaze on the “right” arrow, by performing a selection operation via a portable interface device communicatively coupled to WHUD 210, or by directing his or her gaze to a selection button of visual control interface 215) that he/she wishes to select the “right” arrow at which he/she is gazing. In response, a wireless transmitter 218 of WHUD 210 transmits a wireless signal 250 that encodes or embodies data and/or instructions that, when received by a wireless receiver 228 of helicopter 220, cause helicopter 220 to perform the “move right” operation corresponding to the “right” arrow icon 216 selected by the user via visual control interface 215.

A person of skill in the art will appreciate that visual control interface 215 in application 200 represents a simplification, for the purpose of example, of the controls that may be applied to an RC helicopter. In practice, visual control interface 215 may include far more elaborate controls (e.g., pitch, yaw, roll, rotor speed, and so on) beyond the simple two-dimensional directional controls illustrated in FIG. 2.

The present systems, devices, and methods describe WHUDs that are operative to wirelessly control other electronic devices. For such operation, each WHUD (110, 210) described herein includes an eye tracker (117, 217) via which the user identifies (e.g., by directional gazing) a particular icon corresponding to a particular control function from a visual control interface and a mechanism by which the user selects the particular icon/control function. In some implementations, the selection mechanism is on-board or within the WHUD itself (e.g., gaze dwell time, or other mechanisms such as an on-board select button, a microphone to detect a verbal selection command, and so on); however, in other implementations the selection mechanism is provided by a separate portable interface device. In the latter implementation, the functions of a remote controller may be distributed across a multi-component wearable system that includes a WHUD.

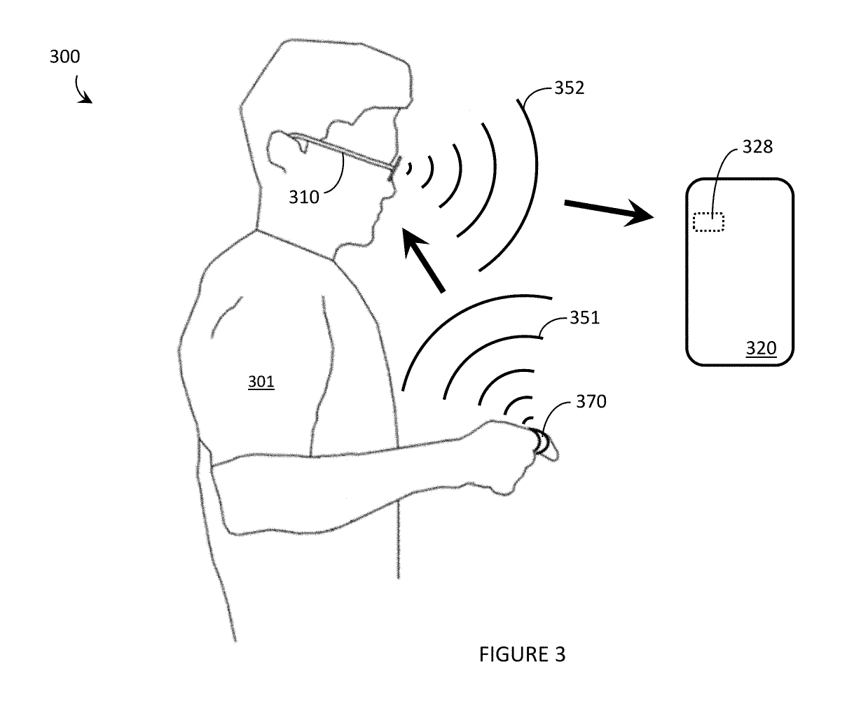

FIG. 3 is an illustrative diagram showing a human-electronics interface in the form of a wearable system 300 that enables a user 301 to easily and discreetly wirelessly control a separate electronic device 320 in accordance with the present systems, devices, and methods. Wearable system 300 comprises a WHUD 310 and a portable interface device 370. WHUD 310 is substantially similar to WHUD 110 from FIG. 1 and/or WHUD 210 from FIG. 2. In FIG. 3, portable interface device 370 is shown having the form factor of a ring or band worn on a finger of user 301; however, in alternative implementations portable interface device 370 may adopt a different form factor and be worn elsewhere on/by user 301, such as a wristband, an armband, or a device that clips, affixes, or otherwise couples to user 301 or to an article of clothing worn by user 301. Portable interface device 370 may be a batteryless and wireless communications portable interface device as described in U.S. Provisional Patent Application Ser. No. 62/236,060 (now U.S. Non-Provisional patent application Ser. No. 15/282,535). Generally, portable interface device 370 includes at least one sensor, button, or actuator that, when activated by user 301, causes portable interface device 370 to wirelessly transmit a first wireless signal 351 (i.e., a selection signal, e.g., radio, infrared, or ultrasonic selection signal). If such a selection signal 351 is wirelessly received by WHUD 310 while WHUD 310 is displaying a visual control interface (115, 215) to user 301 and while an eye tracker (117, 217) of WHUD 310 detects that user 301 is gazing at a particular user-selectable icon (116, 216) of the visual control interface (115, 215), then WHUD 310 interprets that user 301 selects that particular control function (116, 216) to be performed by electronic device 320. Accordingly, WHUD 310 wirelessly transmits a second wireless signal 352 (i.e., a control signal, or a signal that causes electronic device 320 to effect at least one control function when the signal is received by electronic device 320). When the second wireless signal 352 is received by a wireless receiver 328 of electronic device 320, electronic device 320 processes the second wireless signal 352 and, in response, effects the corresponding control function itself.

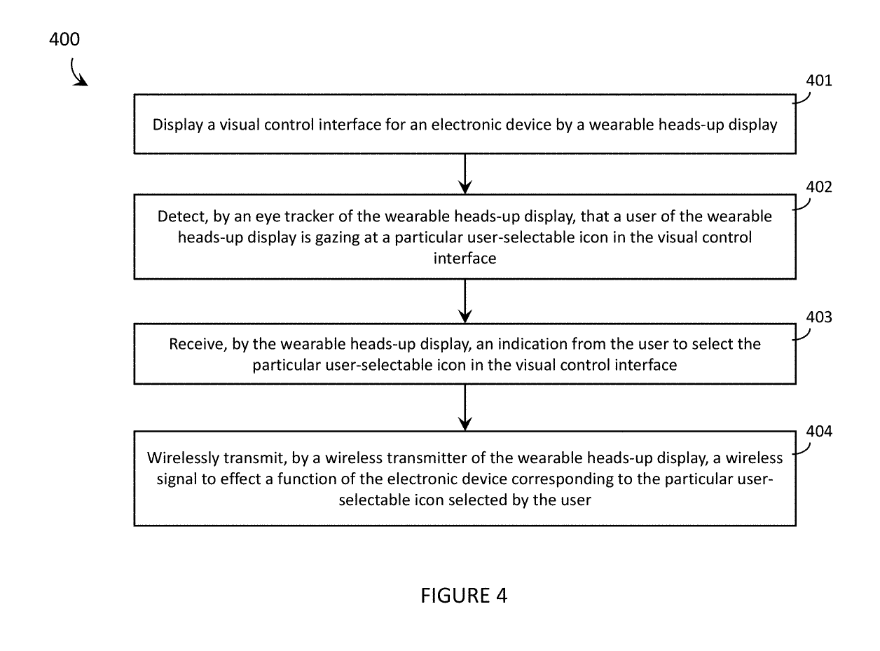

FIG. 4 is a flow-diagram showing an exemplary method 400 of operating a wearable system as a remote-controller to wirelessly control an electronic device in accordance with the present systems, devices, and methods. The wearable system comprises at least a WHUD (e.g., 110, 210, 310) with an eye-tracker (e.g., 117, 217) and a wireless transmitter (118, 218). Throughout the description of method 400 that follows, reference is often made to the elements of application 100 using WHUD 110 from FIG. 1. A person of skill in the art will appreciate that the elements of application 100 are cited in relation to various acts as illustrative examples only and that the methods described herein may be implemented using systems and/or devices that differ from exemplary application 100 illustrated in FIG. 1. The scope of the present systems, devices, and methods should be construed based on the appended claims and not based on the illustrative example embodiments described in this specification. For this reason, throughout the description of method 400 references to elements of application 100 from FIG. 1 are placed in parentheses to indicate that such references are non-limiting and used for illustrative purposes only.

Method 400 includes four acts 401, 402, 403, and 404, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 401, at least one display (111) of the WHUD (110) displays a visual control interface (115) for an electronic device (120). The visual control interface (115) includes at least one user-selectable icon (116) that corresponds to a particular function or operation for the electronic device (120). In other words, the visual control interface (115) may include a set of user-selectable icons (116) that each correspond to a respective function or operation for the electronic device (120), where the set of user-selectable icons (116) includes one or more user-selectable icon(s). Each user-selectable icon may visually take the form of, for example: a user-selectable icon (e.g., pictorial representation, textual representation, and/or graphical button representation) corresponding to a particular control function for the electronic device.

At 402, the eye tracker (117) of the WHUD (110) detects that a user of the WHUD (110) is looking/gazing at a particular user-selectable icon (116) in the visual control interface (115).

At 403, the WHUD (110) receives an indication from the user to select the particular user-selectable icon (116) in the visual control interface (115) at which the user is looking/gazing. As described previously, this indication from the user may come in a variety of different forms depending on the specific implementation being employed. As a first example, the eye tracker (117) of the WHUD (110) may detect that the user is continuously gazing/looking at the particular user-selectable icon (116) for a defined amount of time (e.g., a defined “dwell time,” such as about one second, about two seconds, about three seconds, about four seconds, or about five seconds) and interpret this as an indication from the user to select the particular user-selectable icon (116) at which the user is gazing/looking. As a second example, the wearable system may further include a portable interface device (e.g., 370 from FIG. 3) and the WHUD (110) may receive a wireless selection signal (e.g., 351) from the portable interface device (370) deliberately actuated by the user as an indication from the user to select the particular user-selectable icon (116) at which the user is gazing/looking when the wireless signal (351) is received by the WHUD (110). As previously described, exemplary portable interface devices include, without limitation: a smartphone, a gesture control armband, a wearable device, and a batteryless and wireless communications portable interface device such as that described in U.S. Provisional Patent Application Ser. No. 62/236,060 (now U.S. Non-Provisional patent application Ser. No. 15/282,535). As a third example, the eye tracker (117) of the WHUD (110) may detect that the user gazes at a selection button displayed in the visual control interface (115) immediately (i.e., within a defined time, such as within 0.5 seconds, within 1 second, within 2 seconds, or within 3 seconds) after the eye tracker (117) has detected that the user has gazed at a particular user-selectable icon (116) and interpret this as an indication from the user to select the particular user-selectable icon (116) at which the user has most recently gazed.

At 404, the wireless transmitter (118) of the WHUD 110 wirelessly transmits a wireless signal (150, 352) to effect a function of the electronic device (120) corresponding to the particular user-selectable icon (116) selected by the user. The wireless signal may encode, carry, or embody data and/or instructions that, when received and processed by the electronic device (120), cause the electronic device (120) to effect or perform a function or operation that corresponds to the user-selectable icon (116) for the electronic device (120) selected by the user.

For completeness (i.e., in order to fully realize the control function selected by the user), method 400 may be extended to include the reactive acts performed by the electronic device (120). Specifically, the electronic device (120) may wirelessly receive the wireless signal (150, 352) that was wirelessly transmitted by the WHUD (110) at 404 and, in response thereto, the electronic device (120) may effect a function or operation of the electronic device (120) corresponding to the particular user-selectable icon (116) selected by the user.

The electronic device (120) being wirelessly controlled by method 400 may include virtually any remotely or wirelessly controllable electronic device, such as without limitation: a remote-controlled (RC) toy or vehicle, a television, a personal computer, a laptop computer, one or more specific application(s) running on a personal computer, a music player, a telephone, a smart or networked thermostat, a smart or networked light bulb, a radio, and/or a video game console.

Generally, the WHUD (110) may include a processor (112) and a non-transitory processor-readable storage medium or memory (113) communicatively coupled to the processor (112). The memory (113) may store data and/or processor-executable instructions (114) that, when executed by the processor (112) cause the WHUD to perform acts 401, 402, 403, and 404 of method 400.

A further example of an application in which it can be particularly advantageous to use a WHUD as a remote controller to wirelessly control another electronic device is in navigating through slides or other electronic content during a presentation, seminar, or lecture. Conventionally, a lecturer, presenter, or orator may use a handheld remote controller (e.g., a “presentation clicker”) to move forwards and backwards through slides (e.g., Microsoft PowerPoint® slides, Google Slides® slides, Keynote® slides, or similar) while he/she gives a presentation. Consequences of this approach include: the presenter must hold the presentation clicker in his/her hand throughout the presentation and the presenter typically must turn to look at the presentation monitor to confirm that the displayed content has changed in response to activation of the presentation clicker. In accordance with the present systems, devices, and methods, a WHUD (such as WHUD 110 or 210) or a wearable system including a WHUD (such as system 300) may be used to wirelessly control presentation software running on, for example, a personal computer such as a desktop or laptop computer. The WHUD may display a visual control interface including, at least, “slide forward” and “slide backward” icons and the user may select the desired action using a combination of eye tracking and a selection mechanism (e.g., dwell time, a selection action performed using a separate interface device, or a selection button) as described herein. This application has the further benefit that, in addition to displaying a visual control interface to navigate through presentation slides, the WHUD may concurrently display the slides themselves to the user and/or speaking notes corresponding to the slides to the user. In this way, the WHUD may provide the user with visual access to the displayed content in real-time without requiring the user to turn his/her back to the audience in order to glance at the presentation monitor, and furthermore the WHUD may provide the user with presentation notes and/or actual prepared text (e.g., like a teleprompter) that the user has planned in advance to say during the presentation, all in a discreet manner that is essentially concealed from the audience. Using a WHUD as a remote controller to navigate through presentation materials frees up the users hands (when compared to the use of a conventional handheld presentation clicker), enables the user to see verification that the displayed content has changed without having to turn his/her back on the audience in order to inspect the presentation monitor, and enables the user to, if he/she so chooses, seem to make eye contact with the audience while essentially reading his/her entire presentation out loud from text displayed on the WHUD itself.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: U.S. Non-Provisional patent application No. 15/363,970, U.S. Provisional Patent Application Ser. No. 62/261,653, US Patent Publication 2015-0205134, U.S. Non-Provisional patent application Ser. No. 14/749,341 (now U.S. Pat. No. 9,477,079), U.S. Non-Provisional patent application Ser. No. 14/749,351 (now US Patent Application Publication No. 2015-0378161), U.S. Non-Provisional patent application Ser. No. 14/749,359 (now US Patent Application Publication No. 2015-0378162), U.S. Provisional Patent Application Ser. No. 62/117,316 (now U.S. Non-Provisional patent application Ser. Nos. 15/046,234 and 15/046,269), U.S. Provisional Patent Application Ser. No. 62/134,347 (now US Patent Application Publication No. 2016-0274365), U.S. Provisional Patent Application Ser. No. 62/156,736 (now U.S. Non-Provisional patent application Nos. 15/145,576, 15/145,609, and 15/145,583), U.S. Provisional Patent Application Ser. No. 62/242,844 (now U.S. Non-Provisional patent application Ser. No. 15/046,254), U.S. Provisional Patent Application Ser. No. 62/167,767 (now U.S. Non-Provisional patent application Ser. Nos. 15/167,458, 15/167,472, and 15/167,484), U.S. Provisional Patent Application Ser. No. 62/245,792 (now U.S. Non-Provisional patent application Ser. No. 15/331,204), U.S. Provisional Patent Application Ser. No. 62/236,060 (now U.S. Non-Provisional patent application Ser. No. 15/282,535), are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable system operative to wirelessly control an electronic device, the wearable system comprising:
a wearable heads-up display that includes:
a processor;
an eye tracker communicatively coupled to the processor;
a wireless transmitter communicatively coupled to the processor; and
a non-transitory processor-readable storage medium communicatively coupled to the processor, wherein the non-transitory processor-readable storage medium stores data and/or processor-executable instructions that, when executed by the processor, cause:
the wearable heads-up display to display a visual control interface for the electronic device, the visual control interface including a set of user-selectable icons that each correspond to a respective function for the electronic device;
the eye tracker to detect that a user of the wearable heads-up display is gazing at a particular user-selectable icon in the visual control interface; and
in response to receiving, by the wearable heads-up display, an indication from the user to select the particular user-selectable icon in the visual control interface, the wireless transmitter of the wearable heads-up display to wirelessly transmit a wireless signal to effect a function of the electronic device corresponding to the particular user-selectable icon selected by the user.

2. The wearable system of claim 1 wherein the electronic device is selected from a group consisting of: a remote-controlled device, a television, a personal computer, a laptop computer, a music player, a telephone, a thermostat, a light bulb, a radio, and a video game console.

3. The wearable system of claim 1 wherein the set of user-selectable icons in the visual control interface displayed by the wearable heads-up display includes at least one user-selectable icon selected from a group consisting of: a graphical icon corresponding to a particular function for the electronic device, a textual icon corresponding to a particular function for the electronic device, a pictorial icon corresponding to a particular function for the electronic device, and a combined textual and pictorial icon corresponding to a particular function for the electronic device.

4. The wearable system of claim 1 wherein the data and/or processor-executable instructions, when executed by the processor, further cause the eye tracker to detect that the user is continuously gazing at the particular user-selectable icon for a defined amount of time and, in response to detecting that the user is continuously gazing at the particular user-selectable icon for the defined amount of time, provide the indication to select the particular user-selectable icon in the visual control interface.

5. The wearable system of claim 4 wherein the defined amount of time is selected from a group consisting of: about one second, about two seconds, about three seconds, about four seconds, and about five seconds.

6. The wearable system of claim 1, further comprising a portable interface device that in use is carried or worn by the user, wherein the portable interface device includes at least one actuator that, when activated by the user, causes the portable interface device to wirelessly transmit a selection signal, and wherein:
the data and/or processor-executable instructions stored in the non-transitory processor-readable storage medium of the wearable heads-up display that, when executed by the processor of the wearable heads-up display, cause, in response to receiving, by the wearable heads-up display, an indication from the user to select the particular user-selectable icon in the visual control interface, the wireless transmitter of the wearable heads-up display to wirelessly transmit a wireless signal to effect a function of the electronic device corresponding to the particular user-selectable icon selected by the user, cause:
in response to wirelessly receiving, by the wearable heads-up display, the selection signal from the portable interface device, the wireless transmitter of the wearable heads-up display to wirelessly transmit a wireless signal to effect a function of the electronic device corresponding to the particular user-selectable icon selected by the user.

7. The wearable system of claim 6 wherein the portable interface device is selected from a group consisting of: a smartphone, a gesture control armband, a wearable device, a portable interface device, and a batteryless and wireless portable interface device.

8. The wearable system of claim 1, further comprising a portable interface device that in use is carried or worn by the user, wherein the portable interface device includes at least one actuator that, when activated by the user, causes the portable interface device to wirelessly transmit a selection signal, and wherein the indication from the user to select the particular user-selectable icon in the visual control interface includes a receipt, by the wireless receiver of the wearable heads-up display, of the selection signal wirelessly transmitted by the portable interface device when the at least one actuator of the portable interface device is activated by the user.

9. The wearable system of claim 1 wherein the data and/or processor-executable instructions, when executed by the processor, further cause the eye tracker to detect that the user is gazing at a selection button in the visual control interface after detecting that the user is gazing at a particular user-selectable icon in the visual control interface and, in response to detecting that the user is gazing at the selection button in the visual control interface after detecting that the user is gazing at the particular user-selectable icon in the visual control interface, provide the indication to select the particular user-selectable icon in the visual control interface.
